(19) United States
(12) Patent Application Publication
(10) Pub. No.: US 2023/0196791 A1
(43) Pub. Date: Jun. 22, 2023

(54) ROAD PAINT FEATURE DETECTION

(71) Applicant: GM Cruise Holdings LLC, San Francisco, CA (US)

(72) Inventors: Shreyans Kushwaha, Burlingame, CA (US); Chia-Wei Lin, Foster City, CA (US); Juan Fasola, San Francisco, CA (US)

(21) Appl. No.: 17/558,261

(22) Filed: Dec. 21, 2021

(51) Int. Cl. G06V 20/56; G06V 10/25; G06V 10/82; G06T 7/73; B60W 40/06; B60W 60/00; G06N 3/08

(52) U.S. Cl. CPC G06V 20/588; B60W 40/06; B60W 60/001; G06N 3/08; G06T 7/73; G06V 10/25; G06V 10/82; B60W 2552/53; B60W 2556/40; G06T 2207/20081; G06T 2207/20084; G06T 2207/30256

(57) ABSTRACT

The disclosed technology provides solutions for enhanced road paint feature detection, for example, in an autonomous vehicle (AV) deployment. A process of the disclosed technology can include steps for receiving image data from a vehicle mounted camera, receiving height map data corresponding to a location associated with the image data, and calculating a region of interest that includes a portion of the image data determined based on the height map data. An image patch is generated by projecting the portion of image data included within the region of interest into a top-down view. The image patch is analyzed to detect one or more road paint features in the top-down view, and, in response to detecting an unlabeled road paint feature, the unlabeled road paint feature is localized based at least in part on the height map data. Systems and machine-readable media are also provided.

### TECHNICAL FIELD

The present technology pertains to autonomous vehicle navigation and control, and more particularly pertains to accurately detecting and localizing road paint features relative to an autonomous vehicle.

### BACKGROUND

An autonomous vehicle is a motorized vehicle that can navigate without a human driver. An exemplary autonomous vehicle includes a plurality of sensor systems, such as, but not limited to, a camera sensor system, a Lighting Detection and Ranging (LIDAR) sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

### BRIEF DESCRIPTION OF THE DRAWINGS

Illustrative embodiments of the present application are described in detail below with reference to the following figures:

FIG. 1 is a diagram illustrating an example autonomous vehicle (AV) environment in which one or more aspects of the disclosed technology can be provided;

FIG. 2 is a block diagram illustrating an example road paint feature detection system, in accordance with some aspects of the present disclosure;

FIG. 3 is a flow diagram of an example process for performing feature detection using AV sensor data, in accordance with some aspects of the disclosed technology;

FIG. 4 is a diagram illustrating an example of a system for managing one or more autonomous vehicles (AVs) in accordance with some aspects of the present technology; and

FIG. 5 is a block diagram of a processor-based computing system that can be configured to implement various aspects of the disclosed technology.

### DETAILED DESCRIPTION

Various examples of the present technology are discussed below. While specific implementations are discussed, it should be understood that this is done for illustration purposes only. The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The disclosed technology addresses a need in the art for a technology that can perform real-time detection, classification and localization of road paint features represented in image data captured by one or more cameras associated with an autonomous vehicle (AV). Autonomous vehicles can make decisions based on localization models that determine where an autonomous vehicle is with respect to surrounding objects. In some aspects, localization is performed using sensors to identify road features and localize or control the autonomous vehicle relative to the road features. For example, based at least in part on the identified road paint features, the AV can be controlled in real-time responsive to its surrounding roadway environment. As will be explained in greater depth below, the road paint features can include, but are not limited to, ‘STOP’ text and stop lines that are painted on the road surface. In some embodiments, road paint features such as ‘STOP’ text and/or stop lines can be detected when an AV is approaching an intersection or other location where stop control might be present. In some cases, ‘STOP’ text and/or stop lines can be detected in an area of the road surface located in front of the AV’s front bumper. The detection area can be associated with a range of distances relative to the AV, for example up to 25 meters away from the AV or the front bumper of the AV. Other distances and detection areas can also be utilized, such that previously un-mapped or otherwise unlabeled road paint features such as ‘STOP’ text and stop lines can be detected, classified, and localized in sufficient time to allow the AV to generate a control response to comfortably slow down and come to a stop at the detected feature. In some examples, the identified road paint features can further include one or more of crosswalks, lane lines, speed bumps, stop text or stop lines located in lanes other than the travel lane of the AV, obstructed road paint, etc. In some cases, the road paint feature detection described herein can be performed based on the AV approaching a known intersection location, as the AV’s a priori knowledge of the intersection may not reflect the current reality. For example, a stop sign might have been installed at an intersection that was previously mapped as having no stop sign control, or the location of the stop line might have been moved at an intersection with known stop sign control, etc. In one illustrative example, the AV can perform real-time detection, classification and localization of unlabeled road paint features that are not included in a pre-existing mapping database (e.g., features for which the AV has no a priori knowledge).

Autonomous vehicle navigation can be dependent on the ability of the AV to detect and make sense of its surrounding environment. In some implementations these navigation functions are performed by the AV using labeled images or other mapping data that correspond to an environment through which the AV is navigating. For example, properly labeled images indicating drivable surfaces (e.g., roadways, intersections, crosswalks, and on-ramps, etc.) are used by the AV to make navigation and planning decisions. If the AV does not have properly labeled images, or does not have labeled images at all, it can be challenging for the AV to correctly and safely make navigation and planning decisions. If the labeled images or mapping data available to the AV are incomplete or not properly updated, the AV may not be able to detect traffic control objects such as stop signs, speed bumps, crosswalks, etc.

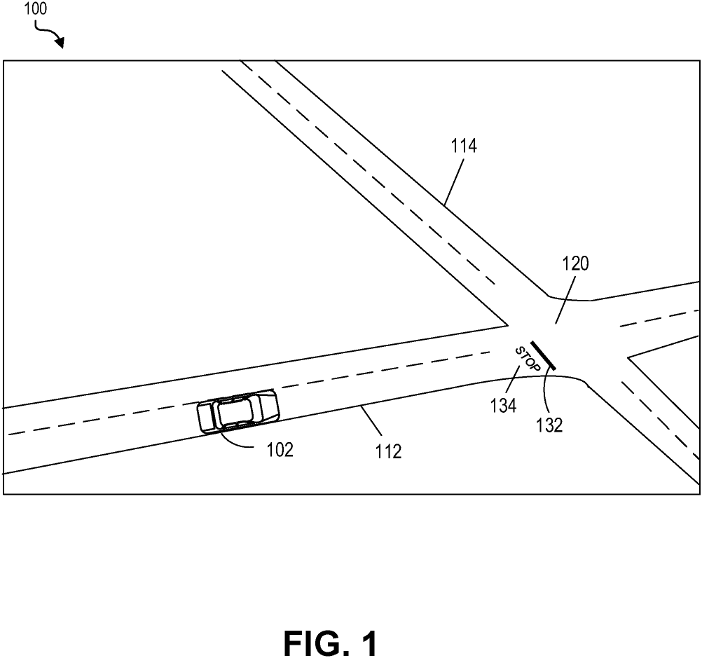

FIG. 1 illustrates an example environment 100 of an autonomous vehicle (AV) 102. As illustrated, AV 102 is traveling on a first road 112 and is approaching an intersection point 120 between the first road 112 and a second road 114. As mentioned previously, safe and correct navigation or control of AV 102 can be dependent on the ability of the AV to both sense its surrounding environment 100 and then further analyze its sensed environment against mapping data or labeled images corresponding to the sensed environment. It can therefore be difficult to achieve safe operation and control of an autonomous vehicle without proper mapping data.

For example, consider a scenario in which, based on the current mapping data available to it, AV 102 determines that it is approaching intersection 120 and that intersection 120 does not have a stop sign or some other form of stop control. However, in actuality, intersection 120 may be undergoing a conversion to a stop sign controlled intersection, e.g., a stop sign is in the process of being installed, as indicated by the presence of a stop line road paint 132 and a ‘STOP’ text road paint 134, but without the presence of a physical stop sign. In some examples, AV 102 should respond to such a scenario by treating intersection 120 as a stop sign controlled intersection, due to the presence of the stop line 132 and the stop text 134.

However, as mentioned previously, AV 102 lacks a priori awareness of the fact that the intersection 120 has transitioned to being stop sign controlled, for example due to outdated mapping data. Although some approaches may attempt to detect and respond to physical stop signs, stop sign installation can consist of at least two separate actions: the installation of the physical stop sign, and the painting of a stop line and/or ‘STOP’ text. If the stop line is painted before the physical stop sign is installed, then in the absence of the system and techniques described herein, AV 102 might enter the intersection 120 without slowing or otherwise coming to a stop at the newly installed stop line 132, thereby violating the stop sign control, or worse, colliding with another vehicle or pedestrian in intersection 120. Moreover, in some cases, physical stop signs may not be as reliably visible (and therefore detectable) as the road paint stop line 132 or ‘STOP’ text 134 located on the road surface. For example, a physical stop sign can be occluded or otherwise obstructed by a variety of different environmental objects both natural and manmade, can be subject to glare and other imaging artifacts and challenges, etc.

In another example, consider a scenario in which according to an AV’s current mapping data, the AV is approaching an intersection with a known stop control such as a stop sign, stop line, crosswalk, etc. However, the location or type of stop control at the intersection might have changed since the AV’s current mapping data was collected, e.g., a new stop sign was added in front of an existing crosswalk, an existing stop sign was moved forward or backward relative to its prior mapped location, etc. In this scenario, in the absence of the systems and techniques described herein, the AV might come to a stop but at the wrong location, which can also be undesirable. For example, if the AV is unaware that an existing stop sign has been moved closer, coming to a stop at the old stop sign location will result in the AV running the re-positioned stop sign. If a crosswalk is located beyond the re-positioned stop sign, then the AV might enter the crosswalk and potentially experience a collision. In another example, if the AV is unaware that an existing stop sign has been moved farther away, coming to a stop at the old stop sign location will result in the AV stopping short of the re-positioned stop sign and potentially experiencing a rear-end collision. As such, systems and techniques for accurately detecting and responding to road paint features (and/or changes in road paint features) in substantially real-time is needed to permit autonomous vehicles to perform appropriately within a changing environment.

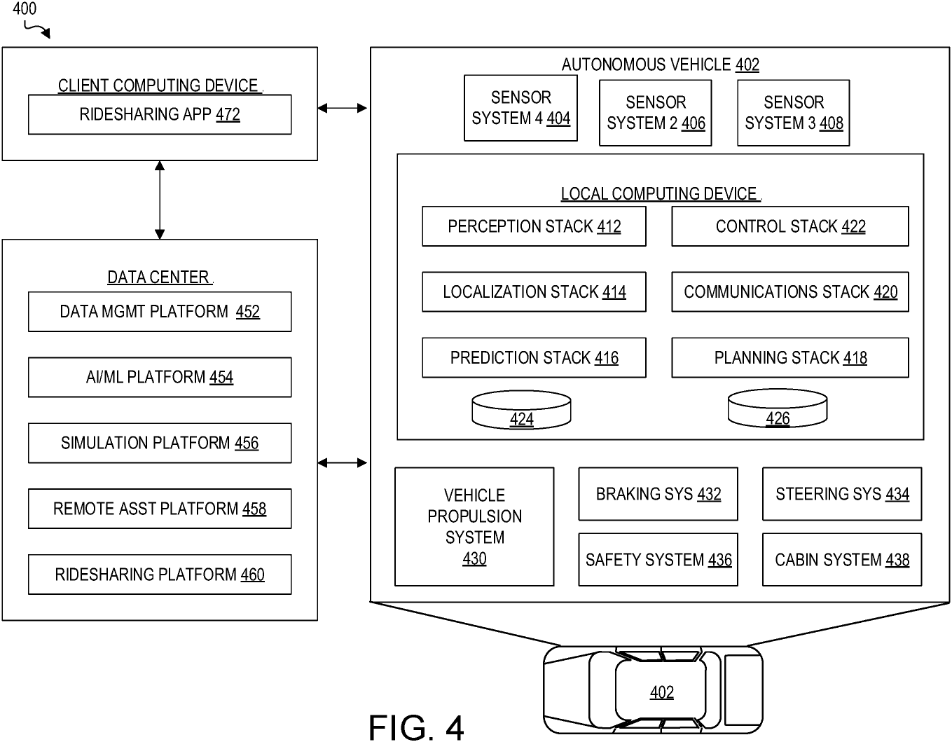

Accordingly, in some embodiments, the road paint feature detection described herein can be performed based on the AV approaching a known intersection location. For example, the road paint feature detection can be triggered by analyzing a current location of the AV against mapping and street information stored in one or more databases (e.g., such as the high definition (HD) geospatial database 126 illustrated in FIG. 4). In some embodiments, one or more pre-determined thresholds can be used to trigger the road paint feature detection, e.g., when the AV is determined to be within a pre-determined distance from a known intersection lane, road paint feature detection can be triggered. The pre-determined thresholds can be static or dynamic. A static threshold can be provided as a fixed distance from the known intersection lane location. A dynamic threshold can calculate a trigger distance for the road paint feature detection based on one or more parameters and/or sensor inputs from the AV. For example, a dynamic threshold can be used to calculate a trigger distance based on factors such as the current speed of the AV, a road/street geometry, weather conditions, traffic conditions, environmental conditions, etc.

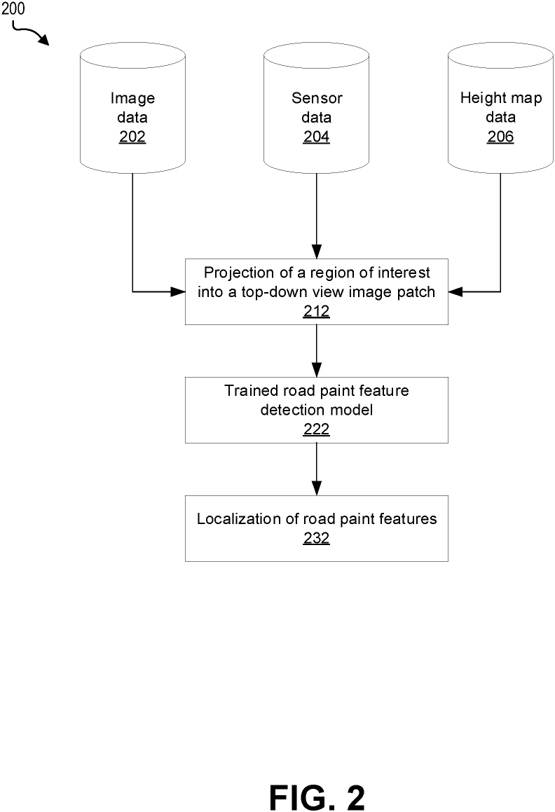

FIG. 2 illustrates a block diagram 200 depicting an example road paint feature detection system 200, according to one or more aspects of the present technology. The road paint feature detection system 200 can be implemented in various systems including, but not limited to, autonomous vehicles, automobiles, motorcycles, trains, and aircraft. For purposes of example, the following discussion is provided in the context of the road paint feature detection system 200 as provided in an autonomous vehicle.

In the example of FIG. 2, the road paint feature detection system 200 can be configured to receive one or more of image data 202, sensor data 204, and height map data 206. In some embodiments, one or more the image data 202, sensor data 204, and height map data 206 can be stored or retrieved from one or more databases. In the context of providing road paint feature detection system 200 at an autonomous vehicle, one or more of the image data 202, sensor data 204, and height map data can be obtained locally at the autonomous vehicle, e.g., sensor data 204 can be obtained at least in part from sensors disposed on or about the autonomous vehicle, image data 202 can be obtained at least in part from one or more vehicle mounted cameras, which can be mounted on or otherwise associated with an autonomous vehicle.

In some examples, height map data 206 can include high-resolution map data with depth information, e.g., three-dimensional (3D) position information. Height map data 206 can additionally or alternatively include distance data, which can be provided in combination with height data indicating a height or elevation corresponding to a particular location or coordinate of the 3D mapping information. In some cases, height map data 206 can include a priori information collected by an AV or otherwise accessible by the AV. Height map data 206 can be collected by any applicable sensors such as a LIDAR (Lighting Detection and Ranging) sensor or a Time of Flight (ToF) camera. In some examples, road paint feature detection system 200 can receive height map data 206 from any applicable database (e.g., a LIDAR database), which can be located locally to the AV or remotely to the AV. In some examples, the height map data 206 can include one or more height measurements that are obtained in an online (e.g., real-time) fashion by one or more sensors disposed upon or otherwise associated with the AV. For example, in some cases the AV can utilize one or more LIDAR sensors to obtain height map data 206 and/or to supplement or augment existing height map data.

In the context of the presently described road paint feature detection system 200, in some embodiments the height map data 206 can include a plurality of height or elevation values of a road surface, wherein the height or elevation values are associated with a particular point located on the road surface. As will be explained in greater depth below, height map data for the road surface can be used to more accurately detect road paint features in image data 202 and to more accurately localize detected road paint features with respect to the autonomous vehicle (or location from which the image data 202 was obtained).

In some embodiments, the road paint feature detection system 200 can obtain height map data 206 that corresponds to one or more locations represented by the image data 202. For example, the road paint feature detection system 200 can determine a location at which a particular portion (e.g., one or more frames) of image data 202 was captured, and then retrieve the corresponding height map data 206 for the same location. In some embodiments, the height map data 206 can be associated or tagged with location information at the time of its collection, e.g., a mapping vehicle can use LIDAR sensors to obtain height map information that is automatically tagged or associated with one or more coordinates at which the LIDAR sensors were used to obtain the height map information. In some embodiments, the road paint feature detection system 200 can be provided with local storage of height map data 206 covering a large area (e.g., a city), but configured to only load small portions or regions of the overall height map dataset 206. For example, the road paint feature detection system 200 can dynamically determine a current location of the AV and load into memory only a corresponding region contained in the height map dataset 206. In some cases, the height map data 206 can be stored as tiles, with one or more tiles of height map data 206 being loaded into memory or otherwise obtained by the road paint feature detection system 200 according to a location-based rolling tile scheme.

Sensor data 204 can be obtained from sensors associated with the road paint feature detection system 200 and/or an autonomous vehicle implementing the road paint feature detection system 200. In some embodiments, sensor data 204 can be obtained from one or more sensors or components described with respect to the example AV management system 400 of FIG. 4. The sensor data 204 can include live sensor data (e.g., collected in substantially real-time), previously collected sensor data, or some combination of the two. In some embodiments, the sensor data 204 can additionally include calibration information or parameters that characterize one or more physical sensors. For example, the sensor data 204 can include calibration information for a camera that is used to capture the image data 202. The camera calibration information can include extrinsic camera data, e.g., specifying how a particular camera is mounted relative to a navigation frame of the AV and/or relative to the AV itself. The camera calibration information can also include intrinsic camera data, e.g., internal parameters of the camera. In some examples, internal parameters of the camera can include information such as focal length, principal point, skew coefficients, distortion, etc. In some examples, information such as sensor dimension, sensor location, etc., can be included in one or more of the extrinsic camera data and/or the intrinsic camera data. In some embodiments, camera calibration information can be obtained for each camera that is used to capture the image data provided as input to the presently described systems and techniques for road paint feature detection. The camera calibration information can include pre-determined information that is stored by or otherwise made available to the AV. The camera calibration information can additionally (or alternatively) include information that is determined by the AV in real-time, during the course of driving, etc. The camera calibration information can comprise extrinsic and/or intrinsic information that is unique to each camera that allows for a more accurate projection of a real-world location (e.g., corresponding to the region of interest) onto the image data captured by the camera. For example, the camera calibration information can specify compensation information for the specific distortion or other error(s) associated with the image data captured by a given camera.

In some examples, the road paint feature detection system 200 can be configured to use the image data 202, sensor data 204, and height map data 206 to project one or more regions of interest into top-down view image patches (block 212). In some examples, the one or more regions of interest can be identified from a single frame of image data 202, and the top-down view image patches of block 212 can be generated repeatedly as new frames of image data are obtained. In some embodiments, block 212 can process each frame of image data, although it is also possible for block 212 to process only a portion of all the frames of image data that are collected. For example, a pre-determined number of image data frames per second can be processed to generate top-down view image patches.

In some embodiments, multiple regions of interest can be determined or identified for each frame of image data 202 that is received as input to the road paint feature detection system 200. Additionally, each region of interest can be different, e.g., non-overlapping or only partially overlapping. In some examples, each region of interest can be calculated to correspond to a pre-determined area relative to one or more of the AV or the camera that was used to obtain the frame of image data. A region of interest can additionally or alternatively be calculated to correspond to a pre-determined distance relative to the AV and/or the camera that captured the frame of image data, in which case the region of interest can be obtained by as a particular geometric shape or area overlaid onto the image data at the pre-determined distance.

In one illustrative example, three regions of interest can be identified for each frame of image data 202, with a top-down view being generated for each of the three identified regions of interest. The regions of interest can have a same or similar shape (e.g., square) and/or size (e.g., 5 m × 5 m). The regions of interest can also be aligned with one another or otherwise be located on the same plane or along the same axis. For example, the three regions of interest can each be 5 m squares with central points located on the same line/axis extending away from the front of the AV, e.g., in the direction of the AV’s travel). Continuing in the same example, the first region of interest can include the portion of the image data that corresponds to the 5 m square area centered 7.5 m in front of the AV (e.g., the area beginning at 5 m in front of the AV and ending 10 m in front of the AV). The second region of interest can include the portion of image data corresponding to the 5 m square centered 17.5 m in front of the AV (e.g., the area from 15-20 m), and the third region of interest can include the portion of image data corresponding to the 5 m square centered 22.5 m in front of the AV (e.g., the area from 20-25 m). It is noted, however, that the above example is provided for purposes of illustration and is not intended to be construed as limiting - a greater or lesser number of regions of interest can be calculated per frame of image data and the regions of interest can be calculated with various other sizes, shapes, and/or locations without departing from the scope of the present disclosure.

In some examples, the road paint feature detection system 200 can overlay height map data 206 onto image data 202 to generate or otherwise determine one or more regions of interest with a given frame of image data. In some examples, height map data 206 can be overlayed onto image data 202 to generate composite image data, which can subsequently be used to determine one or more regions of interest within a given frame of the image data. For example, image data 202 and height map data 206 can be aligned such that coordinates of the location in image data 202 match coordinates of the location in height map data 206. In some cases, projecting height map data 206 onto image data 202 can include identification of various image objects in image data 202 and height map data 206 and aligning pixel regions corresponding with the various image objects until the image data and height data are properly aligned.

As will be described in greater depth below, the use of height map data 206 to identify the regions of interest within image data 202 can improve the accuracy of projecting a region of interest into a top-down view image patch. For example, the road paint feature detection system 206 can use the height map data 206 to compensate for non-flat road geometry (e.g., front to back incline/decline, side to side incline/decline, etc.) that would otherwise introduce warping or other distortion when projecting the perspective of the image data 202 into the top-down perspective of the image patch generated for a region of interest within the image data.

The image data 202 can be captured from the perspective of a camera that is disposed on or associated with the autonomous vehicle, which most often is similar to the perspective of a human driver (e.g., ‘looking’ down the road in front of the vehicle). In other words, the viewing plane of the image data 202 may be approximately orthogonal to the road surface upon which the AV is traveling.

The viewing plane associated with the top-down view may be parallel to a reference ground plane that is independent of the road surface upon which the AV is traveling, e.g., the top-down view can be a bird’s eye view. Many approaches to top-down projection operate under the assumption that the road surface and the reference ground plane of the top-down view are the same. However, this is not always the case - the road surface and the reference ground plane of the top-down view frequently diverge from one another whenever the road surface is not flat. As such, generating a top-down projection based on the assumption that the road surface and the top-down view ground plane will be inaccurate and experience warping or other distortion wherever the road surface is not flat. Moreover, top-down view that is inaccurate, warped, or distorted will introduce downstream error to any localization process that is performed based on the warped top-down view.

Accordingly, by using the height data 206 to compensate for road surface geometry and height variation, the road paint feature detection system 200 can accurately project the image data regions of interest from the camera’s view frame to the top-down view frame. As will be explained in greater depth below, the accurate projection of the top-down view frame allows the road paint detection system 200 to more accurately localize detected road paint features with respect to the AV. For example, each top-down view can be generated from a region of interest corresponding to a pre-defined area in front of the AV, as mentioned above. Therefore, the pre-defined area in front of the AV can be used to generate first localization information that localizes the top-down view with respect to the AV. By using the height data 206 to minimize or eliminate distortion and other inaccuracies in the top-down view, the road paint detection system can accurately generate second localization information that localizes a detected road paint feature within the top-down view - the first and second localization information can then be combined to accurately localize the detected road paint feature relative to the AV, and command an improved, safer control response by the AV.

As mentioned previously, the presently disclosed systems and techniques for road paint feature detection can be implemented locally at an autonomous vehicle, such that the AV can detect and classify unlabeled road paint features in substantially real-time. For example, in some embodiments the presently disclosed road paint feature detection can be performed in a live or online fashion, as opposed to some approaches that rely on offline processing and detection. As such, based on this real-time detection and classification, an AV is able to generate appropriate navigation and/or control responses to road paint features that are not represented in the AV’s a priori knowledge or existing mapping data information. In some embodiments, a road paint feature that has been detected and classified by the road paint feature detection system 200 can be used to update stored mapping information used by one or more AVs. For example, a classified road paint feature can be transmitted as an update to a central server, database, or other repository for labeled mapping data and associated information, either concurrent with the road paint feature being classified at an AV or shortly thereafter. In some cases, an AV can store classified road paint features output by the road paint feature detection system 200 in an onboard memory until the AV’s current driving session has been completed, at which point the classified road paint features can be uploaded or offloaded and used to update existing mapping data. In some embodiments, in response to the road paint feature detection system 200 generating a classified road paint feature at a particular location, one or more dedicated mapping vehicles can be later deployed to perform an updated mapping process at that location to thereby generate updated map data that reflects the change associated with the road paint feature that was detected and classified by the road paint feature detection system 200.

In some embodiments, the road paint feature detection system 200 can include a road paint feature detection model that has been trained on labeled images of road paint features. For example, the road paint feature detection model can be a neural network trained on a labeled set of example top-down view image patches. In some embodiments, the road paint feature detection neural network can be trained on a labeled set of top-down view image patches that were generated by the presently disclosed road paint feature detection system, e.g., generated as described above with respect to block 212. In some embodiments, the road paint feature detection model can be a convolutional neural network (CNN). In an illustrative example, the road paint feature detection model can be a ResNet-18 convolutional neural network, although it is noted that various other neural network models and architectures can be utilized without departing from the scope of the present disclosure.

In some examples, the road paint feature detection model can be a trained neural network that receives one or more top-down view image patches as input, detects one or more road paint features in each top-down view image patch, and then classifies any road paint features that were detected. In some embodiments, the neural network can be trained to classify detected road paint features over multiple different output categories. The classification output categories can include, but are not limited to: Stop Text; Stop Line; Speed Bump; Crosswalk; Ground; Lane Line; Undetermined; Lead Car (e.g., a vehicle in front of the AV is captured in the image data 202 and obstructs the region of interest on the road surface); notOurStop (e.g., a stop text, stop line, or other classification output is detected on the opposite side of the road relative to the AV’s travel lane); Direction Paint (e.g., text indicating school zones, turn arrows, crossing, etc., also referred to as ‘Other Paint’).

In some embodiments, the trained neural network of the road paint feature detection model may generate false positives over time, e.g., where a false positive occurs when the trained neural network correctly detects a road paint feature but provides an incorrect classification, or provides a road paint feature detection output when in reality no road paint feature is present. In some examples, false positives can be collected and used to generate an additional training data set and used to re-train the road paint feature detection neural network. By generating additional training data sets from false positives, the performance of the road paint feature detection neural network can be improved to become more accurate and robust over time.

In some embodiments, the trained neural network of the road paint feature detection model can be trained using a relatively small dataset. For example, a ResNet-18 CNN can be trained with a training data set comprising 22,000 top-down view image patches (e.g., corresponding to approximately 36 minutes of camera data/image data at 10 Hz). Additionally, the trained neural network can be extensible to infer additional semantic information about a scene in the surrounding environment associated with an AV, without relying upon prior mapping information. For example, the trained neural network can be extended to perform map change detection or live semantic inference.

At block 232, one or more features detected by the trained neural network (e.g., output at block 222) can be localized relative to the autonomous vehicle and/or the camera that captured the image data 202. As mentioned above, the localization can be performed based on existing mapping data and/or labeled map features, a current location of the AV, a current pose of the AV (e.g., position information of the AV within the mapping data), camera calibration information (including intrinsic and extrinsic information associated with the camera that captured image data 202), and/or height map data 206.

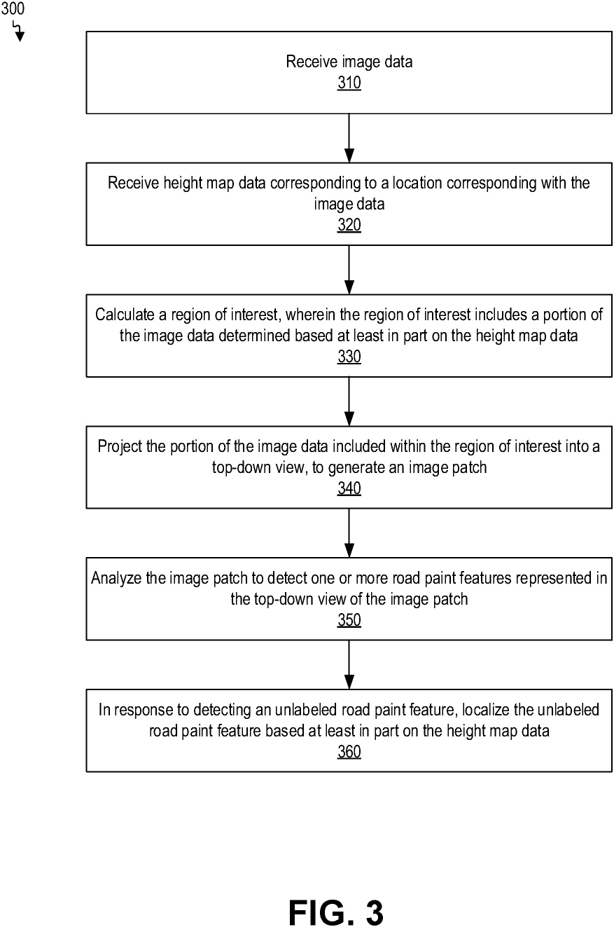

FIG. 3 is a flowchart illustrating an example method for road paint feature detection. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, at block 310 the method includes receiving image data. For example, one or more of the sensor system 404, the sensor system 406, and/or the sensor system 408 illustrated in FIG. 4 may receive image data. In some examples, the image data is obtained from a vehicle mounted camera. The vehicle mounted camera can be mounted on or otherwise associated with an autonomous vehicle. In some examples, at least a portion of the image data obtained from the vehicle mounted camera represents a road surface, such as the road surface upon which the vehicle or AV is traveling at the time the image data is captured.

According to some examples, at block 320 the method includes receiving height map data corresponding to a location associated with the image data. For example, the height map data can be obtained from one or more of the databases 424 and/or 426 illustrated in FIG. 4. In some examples, the height map data can be obtained from one or more remote databases or repositories, e.g., via the communications stack 420 illustrated in FIG. 4. In some examples, the height map data includes a plurality of height data points corresponding to the road surface upon which an autonomous vehicle and/or the camera that captured the image data are located. The height map data can be obtained using one or more LIDAR sensors. In some examples, the method further includes determining a location associated with the image data (e.g., the location at which a given frame of image data was captured) and using the determined location to obtain corresponding height map data. The corresponding height map data can contain height or elevation information for the same location(s) that are associated with the image data or were otherwise determined for the image data. In some examples, the location data can be obtained from one or more location sensors disposed on or associated with an AV. In some examples, the location data can be obtained from one or more of the sensor systems 404, 406, and/or 408 illustrated in FIG. 4.

According to some examples, at block 330 the method includes calculating a region of interest, wherein the region of interest includes a portion of the image data determined based at least in part on the height map data. For example, one or more of the perception stack 412, the prediction stack 416, and/or the planning stack 418 illustrated in FIG. 4 may calculate the region of interest based on the height map data. One or more regions of interest can be calculated for a given frame of image data, and a corresponding one or more image patches can be calculated for each of the regions of interest identified per frame of image data. In some examples, the region of interest calculated comprises a bounding box enclosing image data associated with a planar portion of the road surface. In some embodiments, multiple regions of interest can be determined for a given frame of image data, wherein the regions of interest comprise non-overlapping bounding boxes each enclosing separate portions of image data, the separate portions of image data associated with different planar portions of the road surface. In some examples, the bounding box for a region of interest is parallel to the planar portion of the road surface. In some examples, the planar portion of the road surface is determined based at least in part on the plurality of height data points. In some examples, the region of interest includes a portion of the image data determined based at least in part on the height map data.

According to some examples, at block 340 the method includes projecting the portion of the image data included within the region of interest into a top-down view to generate an image patch. For example, one or more of the perception stack 412, the prediction stack 416, and/or the planning stack 418 illustrated in FIG. 4 may project the portion of the image data included within the region of interest into a top-down view to generate an image patch. In some embodiments, projecting the portion of the image data comprises projecting the image data enclosed by the bounding box determined for the region of interest. In some examples, the image data enclosed by the bounding box is projected onto a plane associated with the top-down view, wherein the plane associated with the top-down view is non-parallel relative to the planar portion of the road surface associated with the bounding box. In some examples, the image patch is generated to represent a road surface area at a pre-determined location relative to an autonomous vehicle associated with the vehicle mounted camera. The road surface area represented by the image patch can be the same as or otherwise correspond to the planar portion of the road surface associated with the bounding box described above with respect to block 340.

According to some examples, at block 350 the method includes analyzing the image patch to detect one or more road paint features represented in the top-down view of the image patch. For example, one or more of the perception stack 412 and/or the AI/ML platform 454 illustrated in FIG. 4 may analyze the image patch to detect the one or more road paint features represented in the top-down view associated with the image patch. In some examples, the one or more road paint features represented in the top-down view include one or more of a stop line, a stop text, a speed bump, and a crosswalk. In some embodiments, the method includes using a convolutional neural network (CNN) to detect the one or more road paint features represented in the top-down view. For example, the CNN can include a ResNet-18 neural network model trained on labeled examples of top-down image patches.

According to some examples, at block 360 the method includes, in response to detecting an unlabeled road paint feature, localizing the unlabeled road paint feature based at least in part on the height map data. For example, the localization stack 414 illustrated in FIG. 4 can localize the unlabeled road paint feature using the height map data. In some examples, the AI/ML platform 454 illustrated in FIG. 4 can localize the unlabeled road paint feature. In some embodiments, localization can additionally be performed by the trained road paint detection neural network described above with respect to block 350, e.g., subsequent to the trained neural network detecting a road paint feature in a given top-down view of an image patch. In some examples, localizing the unlabeled road paint feature can be include performing a first localization to localize the unlabeled road paint feature within the image patch and performing a second localization to localize the image patch relative to the vehicle mounted camera, wherein the unlabeled road paint feature can subsequently be localized relative to an autonomous vehicle based at least in part on the first localization and the second localization.

FIG. 4 illustrates an example of an autonomous vehicle (AV) management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV’s environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and a high definition (HD) geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 414 can determine the AV’s position and orientation (pose) using different methods from multiple systems (e.g., GPS, IMUs, cameras, LIDAR, RADAR, ultrasonic sensors, the HD geospatial database 426, etc.). For example, in some embodiments, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some embodiments, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV’s steering, throttle, brake, and drive unit.

The communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412 - 422, and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 472. The client computing device 470 can be a customer’s mobile computing device or a computing device integrated with the AV 402 (e.g., the local computing device 410). The ridesharing platform 460 can receive requests to pick up or drop off from the ridesharing application 472 and dispatch the AV 402 for the trip.

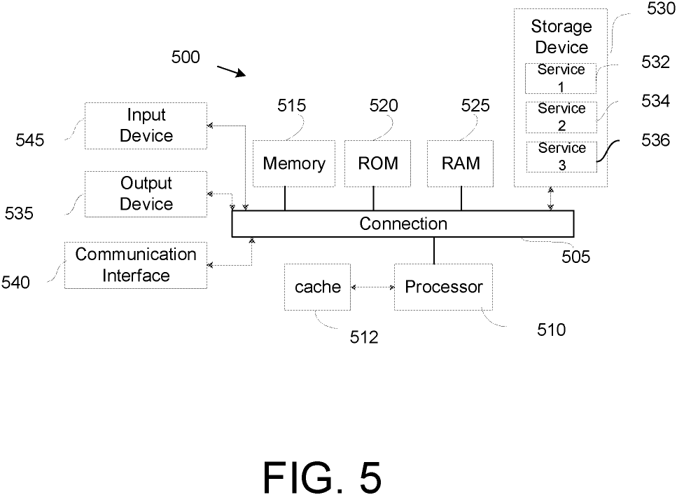

FIG. 5 shows an example computing system 500 with which one or more aspects of the present technology can be implemented. For example, the processor-based computing system 500 can be any computing device making up local computing device 410, data center 450, client computing device 470 or any other device executing the rideshare app 470, as are each illustrated in FIG. 4, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method for road paint feature detection comprising:
receiving image data, wherein the image data is obtained from a vehicle mounted camera;
receiving height map data corresponding to a location corresponding with the image data;
calculating a region of interest, wherein the region of interest includes a portion of the image data determined based at least in part on the height map data;
projecting the portion of the image data included within the region of interest into a top-down view to generate an image patch;
analyzing the image patch to detect one or more road paint features represented in the top-down view; and
in response to detecting an unlabeled road paint feature, localizing the unlabeled road paint feature based at least in part on the height map data.

2. The computer-implemented method of claim 1, wherein:
at least a portion of the image data obtained from the vehicle mounted camera represents a road surface; and
the height map data includes a plurality of height data points corresponding to the road surface.

3. The computer-implemented method of claim 1, wherein the image patch is generated to represent a road surface area at a pre-determined location relative to an autonomous vehicle associated with the vehicle mounted camera.

4. The computer-implemented method of claim 2, wherein the region of interest calculated for the image patch comprises a bounding box enclosing image data associated with a planar portion of the road surface, wherein the planar portion of the road surface is determined based at least in part on the plurality of height data points.

5. The computer-implemented method of claim 4, wherein the bounding box is parallel to the planar portion of the road surface.

6. The computer-implemented method of claim 4, further comprising projecting the image data enclosed by the bounding box onto a plane associated with the top-down view, wherein the plane associated with the top-down view is non-parallel relative to the planar portion of the road surface.

7. The computer-implemented method of claim 1, further comprising using a convolutional neural network to detect the one or more road paint features represented in the top-down view.

8. The computer-implemented method of claim 1, wherein the one or more road paint features represented in the top-down view include one or more of a stop line, a stop text, a speed bump, and a crosswalk.

9. The computer-implemented method of claim 1, further comprising localizing the unlabeled road paint feature by:
performing a first localization to localize the unlabeled road paint feature within the image patch;
performing a second localization to localize the image patch relative to the vehicle mounted camera; and
localizing the unlabeled road paint feature relative to an autonomous vehicle based at least in part on the first localization and the second localization.

10. A system for performing road paint feature detection comprising:
one or more processors; and
a computer-readable medium comprising instructions stored therein, which when executed by the one or more processors, cause the one or more processors to perform operations comprising:
receiving image data, wherein the image data is obtained from a vehicle mounted camera;
receiving height map data corresponding to a location corresponding with the image data;
calculating a region of interest, wherein the region of interest includes a portion of the image data determined based at least in part on the height map data;
projecting the portion of the image data included within the region of interest into a top-down view to generate an image patch;
analyzing the image patch to detect one or more road paint features represented in the top-down view; and
in response to detecting an unlabeled road paint feature, localizing the unlabeled road paint feature based at least in part on the height map data.

11. The system of claim 10, wherein:
at least a portion of the image data obtained from the vehicle mounted camera represents a road surface;
the height map data includes a plurality of height data points corresponding to the road surface; and
the image patch is generated to represent a road surface area at a pre-determined location relative to an autonomous vehicle associated with the vehicle mounted camera.

12. The system of claim 11, wherein the region of interest calculated for the image patch comprises a bounding box enclosing image data associated with a planar portion of the road surface, wherein the planar portion of the road surface is determined based at least in part on the plurality of height data points.

13. The system of claim 12, wherein the instructions further cause the one or more processors to perform operations comprising:
projecting the image data enclosed by the bounding box onto a plane associated with the top-down view, wherein the plane associated with the top-down view is non-parallel relative to the planar portion of the road surface.

14. The system of claim 10, wherein the instructions further cause the one or more processors to perform operations comprising:
using a convolutional neural network to detect the one or more road paint features represented in the top-down view.

15. The system of claim 10, wherein the instructions further cause the one or more processors to localize the unlabeled road paint feature by:
performing a first localization to localize the unlabeled road paint feature within the image patch;
performing a second localization to localize the image patch relative to the vehicle mounted camera; and
localizing the unlabeled road paint feature relative to an autonomous vehicle based at least in part on the first localization and the second localization.

16. A non-transitory computer-readable storage medium comprising instructions stored therein, which when executed by one or more processors, cause the one or more processors to perform operations comprising:
receiving image data, wherein the image data is obtained from a vehicle mounted camera;
receiving height map data corresponding to a location corresponding with the image data;
calculating a region of interest, wherein the region of interest includes a portion of the image data determined based at least in part on the height map data; and
projecting the portion of the image data included within the region of interest into a top-down view to generate an image patch;
analyzing the image patch to detect one or more road paint features represented in the top-down view; and
in response to detecting an unlabeled road paint feature, localizing the unlabeled road paint feature based at least in part on the height map data.

17. The non-transitory computer-readable storage medium of claim 16, wherein:
at least a portion of the image data obtained from the vehicle mounted camera represents a road surface;
the height map data includes a plurality of height data points corresponding to the road surface; and
the image patches is generated to represent a road surface area at a pre-determined location relative to an autonomous vehicle associated with the vehicle mounted camera.

18. The non-transitory computer-readable storage medium of claim 17, wherein the region of interest calculated for the image patch comprises a bounding box enclosing image data associated with a planar portion of the road surface, wherein the planar portion of the road surface is determined based at least in part on the plurality of height data points.

19. The non-transitory computer-readable storage medium of claim 16, wherein the instructions further cause the one or more processors to perform operations comprising:
using a convolutional neural network to detect the one or more road paint features represented in the top-down view.

20. The non-transitory computer-readable storage medium of claim 16, wherein the instructions further cause the one or more processors to localize the unlabeled road paint feature by:
performing a first localization to localize the unlabeled road paint feature within the image patch;
performing a second localization to localize the image patch relative to the vehicle mounted camera; and
localizing the unlabeled road paint feature relative to an autonomous vehicle based at least in part on the first localization and the second localization.
